(19) United States
(12) Patent Application Publication
(10) Pub. No.: US 2008/0257431 A1
(43) Pub. Date: Oct. 23, 2008

(54) Tempering system, device with tempering system, and process for tempering a device and for producing the device

(75) Inventor: Karlheinz Gruber, Esslingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: SINGLE Temperiertechnik GmbH

(21) Appl. No.: 12/148,371

(22) Filed: Apr. 18, 2008

(30) Foreign Application Priority Data
Apr. 23, 2007 (DE) 10 2007 019 369.2

(51) Int. Cl. F16K 11/00

(52) U.S. Cl. 137/597

(57) ABSTRACT

A tempering system for tempering a mold by supplying heat via at least one heating medium, includes a first heating medium circuit and a second heating medium circuit. The first heating medium circuit and the second heating medium circuit are connected by a connecting unit to form an integrated unit having an outlet in working connection with the temperable mold. The connecting unit selectively allows a heating medium at a first temperature or a heating medium at a second temperature to be supplied to the mold, whereby the medium at the first and second temperatures is available to the mold in alternation.

### BACKGROUND OF THE INVENTION

1. Field of the Invention

The present invention relates to a tempering system for tempering connectable pieces of equipment, and particularly for tempering a mold. The present invention also relates to a device for molding workpieces, a process for tempering a device for molding workpieces, and to a process for producing a device.

2. Description of the Related Art

Tempering systems in which a heating medium is stored in a storage unit, brought to a certain temperature by a heat exchanger or heater, sent through a conduit system forming a circuit to other pieces of equipment, and used to temper the connectable pieces of equipment, are generally known.

Tempering systems are also known which use a heating medium to impart heat to connectable pieces of equipment and thus to temper them via two separate circuits, each with a storage unit, a heat exchanger, a heater, and a conduit system. The two circuits allow two different temperatures to be selectively imparted to the connectable piece of equipment.

A disadvantage of these types of tempering systems with two separate circuits is that they require a relatively long time to make different temperatures available to the connected piece of equipment.

### SUMMARY OF THE INVENTION

An object of the present invention to provide a tempering system which, as an integrated unit, makes at least two temperatures selectively available within a shorter time than the prior art.

Another object of the present invention is to provide a device for molding workpieces which comprises an inventive tempering system and a mold which can be tempered by that system.

Yet another object of the present invention is to provide a process which tempers a mold to at least two different temperatures in a shorter time than the prior art.

The object of the present invention is met by a tempering system for tempering connectable pieces of equipment by the use of at least one heating medium to impart heat, the system including first and second heating medium circuits. The first heating medium circuit includes a first conduit system, through which a heating medium can be transferred at a first temperature, and a first unit for tempering the heating medium flowing through the first conduit system. The second heating medium circuit includes a second conduit system, through which a heating medium can be transferred at a second temperature, and a second unit for tempering the heating medium flowing through the second conduit system. The first and second units may comprise heat exchanger units. The first heating medium circuit and the second heating medium circuit are connected into an integrated unit by connecting means so that it is possible to switch between at least two different temperatures whereby the selected temperature is made available to the connectable piece of equipment.

The inventive tempering system according to an embodiment of the present invention comprises in principle two tempering units, each of which has its one heating medium circuit and thus makes available only one heating medium at a predetermined temperature. These two single-circuit tempering units are connected by connecting means, so that the tempering units are connected into an integrated unit. For this purpose, the tempering units have complicated connecting means including, but not limited to pipelines, valves, connectors, and controllers.

The tempering system is designed to selectively supply a connected piece of equipment, that is, a consumer, with different temperatures in alternation, preferably with two different temperatures. The temperatures are adapted to the associated work cycle of the piece of equipment. The temperatures are each provided by heat transfer using a heating medium. The heating medium can be a liquid such as water, preferably water containing an appropriate corrosion-protectant. The tempering system makes available different temperatures by way of the heating medium, preferably temperatures in a range of ≧+15° C. to ≦200° C., or, when a heat-transfer oil is used as the heating medium, to temperatures as high as ≦350° C. The medium is maintained at essentially the same or constant temperature by the circuit in question, although minor heat losses must also be taken into account.

The conduit system in each of the first and second heating medium circuits may comprises pipelines and/or flexible hoses and the like. The conduit system preferably comprises a conveying and/or circulating device such as, for example, a pump, or more precisely a recirculating pump. The conveying device conveys the heating medium through the conduit system. The conduit system has at least one inlet so that it can be supplied with the heating medium. So that the heating medium can be sent to a connected piece of equipment, the conduit system also comprises at least one outlet or flowline. To return the medium from the piece of equipment, the conduit system has a return line. The inlet, the return line, and the outlet are controllable in that they can each respectively be closed.

To bring the heating medium to a desired first temperature, the first heating medium circuit preferably has at least one first heat exchanger unit and/or a first heater. The heat exchanger unit can also be designed as a heater or a cooler. The heat exchanger unit can comprise several heat exchangers, heaters, and/or similar devices.

To temper the heating medium, the first heating medium circuit has an appropriate control system, such as a combination open-loop and closed-loop control system, or a stored-program control system (SPS).

The design of the second heating medium circuit of the tempering system is similar to that of the first heating medium circuit.

So that at least two different temperatures can be made available quickly, the first and second heating medium circuits are connected into an integrated unit by the connecting means, which are designed so that different temperatures, for example, can be provided quickly to the connected piece of equipment. As a result, the molding of a workpiece, i.e., an injection-molded workpiece of plastic, by a connected molding device is optimized.

In an embodiment of the present invention, each of the first and second heating medium circuits comprises a storage unit for storing the heating medium. The storage unit may, for example, be designed as an expansion tank. Together with the conduit system, the storage unit has sufficient volume to make available sufficient heating medium to a connected piece of equipment. When a switch is made from one temperature to another, the heating medium which is no longer needed can flow back to this storage unit and be stored there.

In one embodiment, the connecting means are designed so that the at least two different temperatures can be made available within a time span of ≦10 s, preferably ≦5 s, and more preferably ≦3 s by switching from one heating medium circuit to the other. By making available two integrated heating circuits which are connected to each other, it is possible, by simply switching from one circuit to the other, to make different temperatures available to connected pieces of equipment within a short period of time.

In another exemplary embodiment, the connecting means comprise a switching station, to the inlets of which the outlets of the conduit system are connected. Each heating circuit has an outlet. Each of these outlets leads to an inlet of the switching station. In this way, the two heating circuits can be connected to a switching station, as a result of which the heating circuits are designed as integral parts of each other. The inlets or the outlets can be controlled; in particular, they can be closed. The outlets can in particular be the flowlines.

The same is true analogously for the outlets of the switching station and the inlets or return lines of the circuits. A medium which is no longer needed can flow via the outlets of the switching station to the return line of the circuits, and the medium can thus be returned correspondingly to the associated storage unit.

In another embodiment of the invention, the switching station has at least one outlet which can be connected to the additional piece of equipment, where a mechanism is provided to switch the outlet into fluidic connection with at least one of the inlets. The switching station has an outlet for an additional piece of equipment. If several pieces of equipment are to be tempered, the switching station can have one additional outlet for each piece of equipment. The outlet of the switching station is connected fluidically to the inlets. For this purpose, the switching station has appropriate equipment for performing the switching such as, for example, channels, lines, and valves. By means of a mechanism, the outlet is connected fluidically to the inlets in such a way that, depending on requirements of the connected piece of equipment, an appropriately tempered heating medium can flow through the switching station to the outlet. The switching station can have appropriate-for-the-purpose switches, shut-off elements, and/or bypasses such as valves which direct the flow of the heating medium as desired.

The switching station preferably has a control system, which controls and conducts the flow of heating medium appropriately as a function of the desired requirements, such as those associated with a connected piece of equipment. It is conceivable that only one stream of heating medium is flowing through the switching station at a time. The control system can control the flow in particular as a function of the desired temperature.

According to one embodiment of the tempering system, the connecting means comprise an equalizing device, so that, when a switchover is made, it is possible to equalize a difference with respect to at least one property or parameter between the heating medium in the one heating medium circuit and the heating medium in the other heating medium circuit. The properties or parameters can be any selected properties or parameters of the heating medium including, but not limited to, pressure, temperature, or quantity. Because of the integrated, connected design of the heating medium circuits, unbalanced states occur when a switch is made from one heating medium circuit to the other. These imbalances are corrected as appropriate by the equalizing device. The equalizing device can, like the switching station, comprise conduits, connecting lines, branches, valves, and the like.

The connecting means by which the heating medium circuits are integrated with each other comprise, for example, a common compressed air blanketing unit, as a result of which the heating medium or the heating media can be subjected to pressure. When a switch is made from one heating medium circuit to the other, the pressure, for example, can be equalized by the equalizing device. For this purpose, the equalizing device may, for example, have valves, conduits, pressure reducers, and/or pressure boosters.

In another embodiment, the equalizing device can have a differential quantity compensation unit, which equalizes any differences in quantity which may occur when switching between the heating medium circuits. This differential quantity compensation unit may, for example, comprise conduits, branches, connecting points, valves, throttles, and storage tanks. Any storage tanks which may be present can be integrated into the storage devices of the heating medium circuits and/or be designed as separate units. Any conduits which may be present can connect the one heating medium circuit fluidically to the other heating medium circuit. When the same heating medium is being used in both circuits, it is therefore possible in this way for the heating medium to be equalized between the heating medium circuits.

It is therefore provided that, in one exemplary embodiment, the connecting means comprise an additional conduit system to connect one of the conduit systems of one of the heating medium circuits fluidically to the other heating medium circuit upstream of the switching station. The additional conduit system comprises appropriate hydraulic and/or pneumatic units, especially valves, branches, connecting points, and controllers.

In a preferred embodiment, the equalizing device is connected to the additional conduit system. In this way, it is possible for at least one parameter such as, for example, the pressure or the quantity, to be equalized between the conduits of the first heating medium circuit and those of the second heating medium circuit by way of the supplemental conduits and the equalizing devices connected to them.

According to one embodiment, the equalizing device comprises a medium return flow control unit. When a change is made from the one medium to the other medium, the one medium can return, thus allowing the other medium to be made available. When switching circuits, i.e., from a hot medium to a cold medium, for example, the medium being made available, which is present, say, in the switching station or in an external circuit, flows back into the desired circuit, e.g., into the desired storage unit, tank, etc. If, for example, a cold medium is being made available and a switch is to be made from cold to hot, the cold medium which has been made available to the external circuit and at least some of which is present there flows back into the “cold” circuit, or more precisely, into the corresponding storage unit or a “cold” circulation tank.

In analogous fashion, when a switch is made from a hot medium to a cold medium, the quantity of the hot medium which is just then present in the external circuit flows back into the hot circuit, i.e., for example, into the hot circulation tank.

To implement this feature, a temperature sensor is preferably installed in a return line leading from an external consumer to which the medium is being made available to the switching station. The temperature sensor detects the temperatures of the medium present at the time. It detects in particular the shifting temperature limit between the one, say, hot medium and other, say, cold medium and vice versa. This detected value or the detected values of the sensor are evaluated appropriately, and the tempering system is adjusted appropriately when necessary, that is, during a switchover process. Thus, when a switchover is made, valves in the return line are actuated as appropriate in response to the temperature change. In particular, the valves in the flowline are switched first, and there is a certain delay before the valves in the return line are switched.

The advantageous effect achieved here is that the quantity or volume of a heating medium which is returning from the external circuit does not have to be heated back up or cooled back down again completely. Energy is thus saved in the tempering system, especially under continuous operating conditions. The corresponding heating and cooling systems which the heat exchanger comprises can be made correspondingly smaller, because they are no longer required to make such large amounts of heat available.

In another embodiment of the invention, the connecting means comprise at least one controller to implement the thermal control of at least one heat exchanger unit. The controller preferably implements the thermal control of both heat exchanger units. The controller can be designed as a separate unit, e.g., one for each individual function to be served, or as a central, common controller for multiple functions.

According to another embodiment, the connecting means have a controller for switching the switching station so that it is possible to switch quickly between the different temperatures to be made available. The control can be implemented manually, semi-automatically, or automatically. It is therefore possible to temper a connected piece of equipment as needed. The controller can be designed as a central controller; it can be integrated into a central control system; or it can be designed as an independent controller.

The invention, finally, encompasses the technical teaching that an inventive tempering system and a temperable mold which can be connected to the tempering system are incorporated into a device for molding workpieces. The mold can be any desired temperable mold. In particular, the mold can be a mold which makes it possible to temper it in a manner which follows the mold contours.

In particular, the mold in one exemplary embodiment comprises a channel system for contour-following mold tempering.

The mold is preferably produced according to a process for the production of a tool or a corresponding mold provided with at least one inlet and at least one outlet and internal channels, where the process comprises the following steps of splitting the tool or mold along the planes of the channels to be produced, producing the channels in the parting surfaces of the split tool or mold such as, for example, by milling or erosion in correspondence with the desired layout as a function of the planned volume flow rate of the heating medium and the temperature profile in the molded plastic part, and rejoining the split parts of the tool or mold by hard or high-temperature brazing.

It is also possible, however, to use molds for a contour-following mold temperature produced according to another process. Other molds with cooling channels near the contours can be produced, for example, by laser melting or laser sintering.

The temperable mold comprises at least one cavity for accepting the shape of the molded plastic part to be produced, at least one inlet and one outlet, where the inlet and outlet are connected to each other by channels, and a heating medium channel system for cooling or heating the mold cavity, where the channels extend in several planes, where the course of the channels is adapted to the external shape of the mold cavity, and where the geometry of the channels is adapted to the temperature profile in the molded plastic part. In particular, at least part of at least one channel is parallel to a contour of the molded part.

In one embodiment, the channel system is connected fluidically to an outlet of the switching station by a channel inlet. In this way, the channel system can be supplied with at least one heating medium of the tempering system. By switching over the switching station of the tempering system, the channel system can be supplied in alternation with two different media, i.e., different with respect to at least one property or parameter (i.e., temperature or pressure).

In a preferred embodiment, the channel system comprises several channels. In this way, it is possible to realize an optimal channel layout, especially in the area near the surface of the mold, where the distance between the mold surface and the channel is minimized. The distance is preferably in the range from ≧0.1 mm and ≦10 mm, more preferably from ≧0.2 mm and ≦9 mm, and especially from ≧0.3 mm and ≦8 mm. Because of the short distances involved here, it is possible to exert direct, rapid, and intensive thermal effects on the mold wall temperature.

The contour-following tempering thus made possible is generally used in injection molds, especially those for thermoplastic and/or duo plastic molding compounds. A heating medium or tempering medium stream flowing continuously through one of the channels—heating medium channels—guarantees a locally more-or-less uniform temperature at the wall of the mold cavity. The tempering also applies to metal casting molds, especially in the area of zinc castings, aluminum castings, and/or magnesium castings.

Through the use of the connected tempering system, the flowline temperature for the mold and thus also the wall temperature of the mold cavity can be changed within a very short time. In the case of thick-walled molded parts of metal and plastic, the possibility of achieving a rapid temperature change at the surface of the mold offers numerous advantages.

During the injection of plastic, for example, into the mold cavity, the surface property and the near-surface property of the finished component are determined at the moment of contact between the plastic mass and the mold wall. For many plastics and/or metals, this means that the mold wall temperatures at the moment the mold is filled must be very high to obtain a surface which can be described as being of high quality. In the case of polyamide materials, for example, this temperature must be over 80° C. At the same time, high mold wall temperatures mean that it is necessary to accept longer cooling times for the component in the hot mold. Because the tempering system can make available at least two different temperatures, the cooling time can be drastically reduced. When the mold is being filled, therefore, the system allows the use of a high temperature at the mold wall to ensure that the component will have a high-quality surface.

The ability to produce a workpiece of high surface quality in the shortest possible cycle time is associated with the advantage that the workpiece—an injected part—has greater freedom from distortion. Yet there is even another advantage related to “weld lines” or joint lines in the workpiece.

In complicated workpieces such as injection-molded plastic parts, the required molding compound/plastic compound is injected through several gates into the mold. The injected compound distributes itself in the mold and flows together at one or more points. At the points where the compound flows together, so-called “weld lines” or joint lines are formed, which can represent an optical and technical material defect in the finished workpiece. The tempering system makes it possible to temper the mold in alternating fashion under optimally controlled conditions. Thus the molding compound/molding material can be heated during the flow cycle so that its viscosity is adjusted to ensure that weld lines will be completely or at least almost completely prevented. As an alternative to tempering the entire mold in alternating fashion to avoid weld lines as described above, the entire mold may be tempered conventionally at a constant temperature and to temper in alternation only the part where the weld lines occur in contour-following fashion with cooling by local mold inserts. After the feed process, the tempering system can be switched over to a cooling cycle within a very short time, and the workpiece to be fabricated—the injected part—will cool down very quickly. By using valves to accomplish the switchover, for example, it is possible to change to a colder heating medium or tempering medium so that, after a good surface has been produced, the mold wall temperature can be brought down very quickly during the molding or work cycle, which leads to a significant decrease in time required for the overall process. Switching back to the hotter tempering medium just before the mold is opened has the effect of increasing the mold wall temperature again.

The inventive tempering system can be used effectively especially with molds having channels which closely follow the contours. For it is especially the channels near the contours, through which the tempering medium flows, which make it possible to implement the changes in the mold wall temperature which are necessary for the molding process. In corresponding fashion, the channels should be provided essentially in an area close to the contours. Thus a tempering which follows the contours can be realized to particular advantage by combining an inventive tempering system with a mold with contour-following channels.

According to an embodiment, at least part of at least one of the channels is close to the surface of a contour of the mold. The distance between the contour surface and the channel depends on the dimensions of the channel and on the anticipated internal pressure in the mold and will be in the range of 1.5-10 mm, although in certain embodiments it can also preferably be in the range between ≧0.1 mm and ≦25 mm, more preferably in the range between ≧0.75 mm and ≦15 mm, and especially in the range between ≧1.00 and ≦12.5 mm. The range is selected so that sufficient strength is ensured for operation; that is, the remaining wall thickness must be great enough to withstand the loads which occur during operation.

It is preferable for at least one of the channels which is close to the surface of the contour to be temperable in different ways through actuation of the switching station. In this way, optimized results especially with respect to surface quality can be obtained during the production of workpieces by the device.

The object of the present invention is also met by a process for tempering a device for molding workpieces including the steps of supplying the tempering system described above with at least one heating medium, making two different temperatures available by the minimum of one heating medium, and connecting the mold to the tempering system and tempering the mold by conducting at least one heating medium through the channel system of the mold.

In an additional embodiment of the inventive process, the step of connecting further comprises connecting at least one inlet of the channel system to at least one outlet of the switching station of the tempering system.

In yet another embodiment of the inventive process, the step of tempering further comprises tempering the mold by conducting through it a heating medium at a first temperature and switching over the switching station and tempering the mold by conducting through it a heating medium at a second temperature.

The steps can be executed multiple times in succession. The time between shutting the flow of the first medium and starting the flow of the second medium is preferably less than 10 seconds, more preferably less than 5 seconds, and especially less than 3 seconds.

The object of the present invention is also met by a process for producing an inventive device comprises the following steps producing a tempering system, producing a mold, and connecting the tempering system to the mold.

In one embodiment, the production of the mold comprises a joining process. Any suitable joining process can be used to produce temperable molds with channels near the contours. Production may be carried out by the steps of splitting the tool or mold along the planes of the channels to be produced, producing the channels in the parting planes of the split tool or mold by milling or erosion in correspondence with the desired layout as a function of the planned volume flow rate of the heating medium and the temperature profile in the plastic molded part, and rejoining the split parts of the tool or mold by hard or high-temperature brazing.

Additional invention-improving measures can be derived from the following description of an exemplary embodiment of the invention, which is illustrated schematically in the figures. All features and/or advantages, including designed details, three-dimensional arrangements, and process steps derivable from the claims, from the description, or from the drawings can be essential to the invention either individually or in any conceivable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic side view of a tempering system according to an embodiment of the present invention;

FIG. 2 is a schematic top view of the inventive tempering system according to FIG. 1;

FIG. 3 is a schematic diagram of a device for molding workpieces with a tempering system according to FIGS. 1 and 2 and a mold;

FIG. 4 is a schematic circuit diagram of a heating circuit according to an embodiment of the invention;

FIG. 5 is a schematic circuit diagram of a cooling circuit according to an embodiment of the invention; and

FIG. 6 shows a schematic circuit diagram of a pressure-blanketed tempering system according to yet another embodiment of the invention.

### DETAILED DESCRIPTION OF THE PRESENTLY PREFERRED EMBODIMENTS

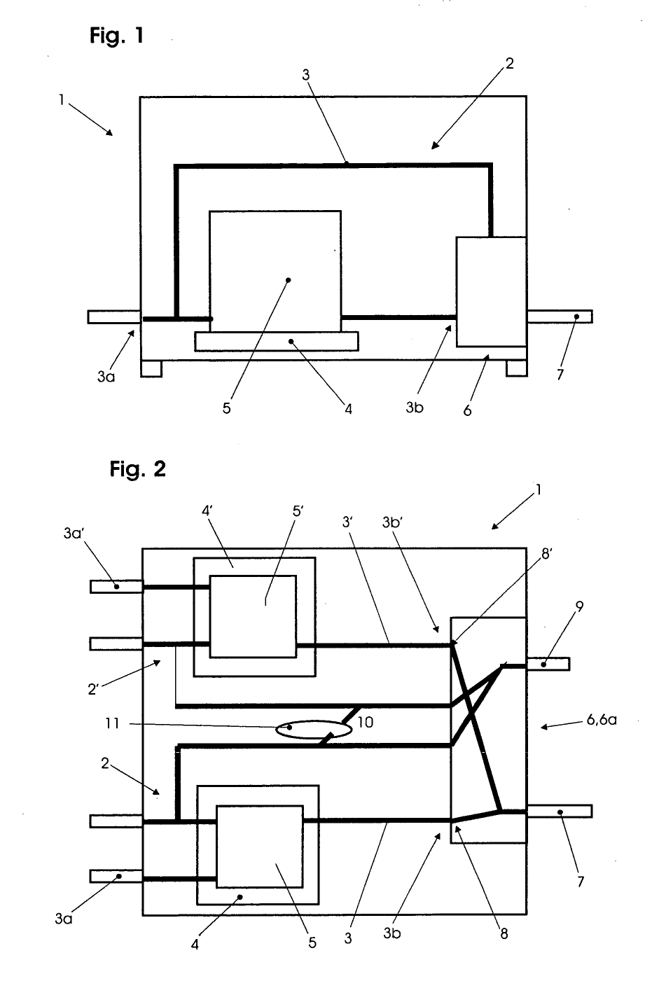

FIG. 1 shows a schematic side view of a tempering system 1. The tempering system 1 comprises a first heating medium circuit 2 and a second heating medium circuit 2′ (not visible here). Parts and components of the second circuit are usually designated by a reference character with an apostrophe, whereas parts and components of the first circuit are characterized by the absence of the apostrophe. The two heating medium circuits 2, 2′ are similar in design to each other, so that, with respect to FIG. 1, only the first heating medium circuit 2 visible in FIG. 1 is described. This description then applies analogously to the second heating medium circuit 2′.

The first heating medium circuit 2 comprises a first conduit system 3, a first heat exchanger unit 4, and a first storage unit 5. The conduit system 3 comprises a first inlet 3a and a first outlet 3b. A first heating medium can be supplied to the heating medium circuit 2 through the first inlet 3a. The first heating medium is preferably a liquid, more preferably water, and especially water with corrosion-protectant. The heating medium passes through the conduit system 3 to the storage device 5. There the heating medium is heated to a desired first temperature by the heat exchanger unit 4, which is in working connection with the storage device 5. The heat exchanger unit 4 can also be set up in some other location in the conduit system 3 in effective heat-transferring connection with the heating medium. Several heat exchanger units can also be provided.

The tempering system 1 also comprises connecting means 6, integrally connecting the two heating medium circuits 2, 2′ to each other. The outlet 3b of the first heating medium circuit 2 is connected fluidically to the connecting means 6. The connecting means 6 comprise an outlet 7, via which additional pieces of equipment, such as a mold, can be connected.

FIG. 2 shows a schematic top view of the inventive tempering system 1 according to FIG. 1. The same reference numbers refer to the same components, and therefore a detailed description of components which have already been described can be omitted. Here as well, an apostrophe after the reference character designates components of the second heating medium circuit, whereas reference numbers without an apostrophe designate components of the first heating medium circuit or components of both heating medium circuits.

The first and second heating medium circuits 2, 2′ are essentially of the same design, and therefore whatever is said about one of the heating medium circuits also applies analogously to the other, unless it is explicitly stated that there are differences. “First” components refer to the first heating medium circuit 2, whereas “second” components refer to the second heating medium circuit 2′.

Each heating medium circuit 2, 2′ comprises a conduit system 3, 3′, a heat exchanger unit 4, 4′, and a storage device 5, 5′. Each of the conduit systems 3, 3′ comprises an inlet 3a, 3a′ and an outlet 3b, 3b′. Via the inlet 3a, 3a′, a heating medium can be supplied to the heating medium circuit 2, 2′. The heating medium is preferably a liquid, especially water. The outlets 3b, 3b′ are connected to the inlets 8, 8′ of the connecting means 6, where the inlet 8 is assigned to the first heating medium circuit 2, the inlet 8′ to the second heating medium circuit 2′. The connecting means 6 comprise in the present case a switching station 6a. The switching station 6a has the inlets 8, 8′; the outlet 7, designed as a flowline; and the outlet 9, designed as the return line. The switching station 6a has conduits, which fluidically connect the inlets 8, 8′ to the outlet 7, so that a heating medium can be conducted from the heating medium circuits 2, 2′ to the outlet 7. The switching station 6a has further conduits connected to the outlet 9 (return line) for conducting heating medium which has flowed through the connectable equipment. The switching station 6a has an appropriate mechanism (not shown) which makes it possible for a heating medium of one of the heating medium circuits 2, 2′ to be selected effectively for passage through the switching station 6a or for partial streams of the heating medium circuits 2, 2′ to be conducted through the switching station 6a. The mechanism may, for example, comprise a circuit consisting of valves, bypass devices, and sliders.

In the embodiment shown here, the connecting means 6 also comprise an additional conduit system 10 (indicated schematically by the broken line at 10). Via the additional conduit system 10, which can comprise multiple conduits, the two heating medium circuits 2, 2′ are connected for the purpose of equalization at times such as those when a switchover is performed. An equalizing device 11 is provided to handle the equalization between the heating medium circuits 2, 2′. The equalizing device 11, which in the present case is integrated into the system by the additional conduit system 10, equalizes different properties or parameters of the heating medium such as pressure, temperature, and quantity, with the result that it becomes easy to switch over quickly and easily from one heating medium circuit 2, 2′ to the other heating medium circuit 2′ 2.

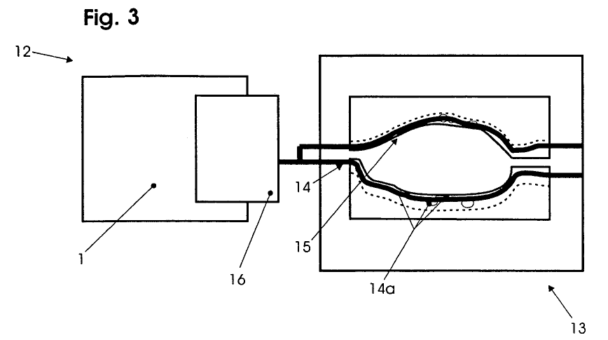

FIG. 3 shows a schematic diagram of a device 12 for molding workpieces which includes the tempering system 1 according to FIGS. 1 and 2 and a mold 13. The mold 13 has a channel system 14 for contour-following mold tempering. The channel system 14 comprises various channels 14a, which are indicated here only in schematic fashion. The channel system 14 is connected to the outlet 7, shown in FIGS. 1 and 2, of the switching station 6a of the tempering system 1, so that the heating medium of the tempering system 1 can flow through the channels 14a of the channel system 14. The channels 14a can proceed in different directions, as shown. The channels 14a follow the contour, a short distance away from a contour-forming surface 15 of the mold 13, i.e., the surface which determines the shape of the workpiece to be molded. In the shape-defining area, the channels 14a are close to the contour surface 15, that is, they are in the area illustrated schematically by the broken line. The area is designed in such a way that the distance between the contour-following channels 14 and the surface 15 is in the range from ≧0.1 mm to ≦25 mm, preferably from ≧0.75 mm to ≦15 mm, more preferably in a range from ≧1.0 mm to ≦12.5 mm, and especially between about 1.5 and 10 mm.

The tempering system 1 comprises a controller 16. Although only one controller 16 is shown, the tempering system may comprise a plurality of controllers, each controlling one or more specific control function or functions described below. The controller 16 automatically controls the tempering, that is, the temperature of the heating medium or heating media. In addition, the controller 16, integrated as a common controller or designed as a separate controller, can be used to control the switching between the heating medium circuits 2, 2′. As a function of the mold 13, the controller 16 can control the tempering of the mold 13 by appropriately actuating the switching station 6a, for example, or by automatically controlling the temperature of the heating media, or by adjusting the pressure.

So that a workpiece can be molded by the device 12, the tempering system 1 is supplied with a heating medium, preferably with a liquid, here water. The properties or parameters of the water in the one heating medium circuit 2 differ from those of the water in the other heating medium circuit 2′. In the present case, their temperatures are different. The water being used as heating medium can be prepared in the storage device 5 and/or the conduit system 3 and the like shown in FIGS. 1 and 2. The mold 13 is connected to the tempering system 1. After the connection has been established, the tempered heating medium can be conducted through the channel system 14 of the mold 13. The surface 15 is quickly tempered by the channels 14a, at least some of which are close to the contour. To ensure optimal formation of the molded workpiece, appropriate switching is then carried out to conduct the other heating medium, as needed, through the channel system 14 of the mold 13. The heating medium previously present is conducted as appropriate via conduits (not shown) back to the return line of the tempering system 1.

The conduit systems can comprise various conduit sections, such as parallel conduits, branches, manifolds, bypass lines, tapering conduit sections, extending conduit sections, closable conduit sections, and throttle points. In this way, it is possible to build complex conduit systems which can be adapted as necessary to the requirements of each specific task.

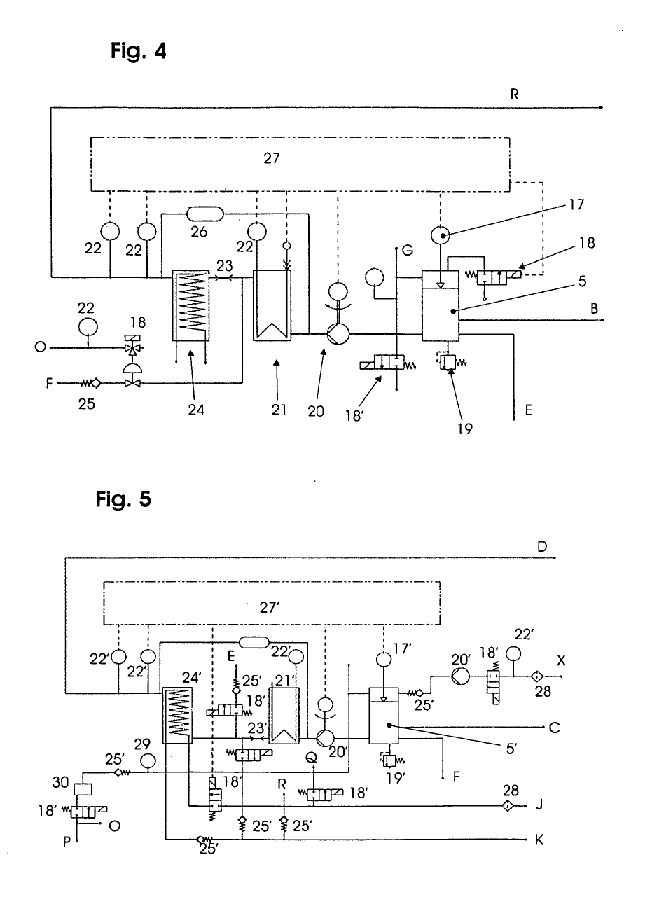

FIG. 4 shows a schematic circuit diagram of a heating circuit, that is, of the first heating medium circuit 2, in which the first medium has a higher temperature than the second medium.

Via an inlet E, a first medium such as water is sent to a first storage unit 5. The storage unit 5 has a liquid-level float switch 17, which switches on and off as a function of the quantity of medium present in the unit. A return line B also leads to the storage unit 5. Via this line the medium coming from a consumer can be fed back to the storage unit 5. A solenoid-operated valve 18 is also connected to the storage unit 5 shown here. In addition, a safety valve 19 is connected to the storage unit 5. In the upper area of the storage unit 5, a conduit leaves the storage unit 5 and proceeds to a conduit G. By way of another solenoid-operated valve 18, the conduit G connects the heating circuit to the cooling circuit, not shown here (see FIG. 2). From the lower area of the storage unit 5, a conduit leads by way of a pump unit 20 to a heater 21. The heater 21 has a temperature sensor 22, which detects the film temperature of the medium in the heater 21. The heater 21 is adjusted by a controller 27. From the heater, a conduit leads by way of a throttle 23 to a heat exchanger 24, via which heat can be imparted to or carried away from the medium. A conduit, which is connected to the second circuit at O and F, leads to the line which leads to the throttle 23. The conduit coming from O has a temperature sensor 22 and is connected by way of a solenoid-operated valve 18 to the conduit coming from F, which has a check valve 25. The flowline A proceeds from the heat exchanger 24. Immediately downstream of the heat exchanger 24, the flowline A has a feedback connection to the section immediately upstream of the heater 21 by way of, for example, a pressure differential transmitter 26 with a PDS controller. The temperature in the flowline A downstream (in accordance with the direction of flow) of the heat exchanger is detected by two temperature sensors 22. A stored-program control system (SPS) or an automatic temperature controller is illustrated at 27 as a box in broken line. This SPS acquires the detected data, e.g., the data from the temperature sensors, and processes them. The SPS then generates and transmits corresponding actuating signals, such as signals for the pump unit (at 20) or solenoid-operated valves (at 18).

FIG. 5 shows a schematic circuit diagram of a cooling circuit. The cooling circuit comprises the second heating medium circuit 2′ and is connected to the first heating medium circuit 2. The cooling circuit has a storage unit 5′, which can be supplied with a medium (e.g., water) through a filling conduit X. The filling conduit X has a dirt catcher 28, a temperature sensor 22′, a solenoid-operated valve 18′, a pump unit 20′, and a check valve 25′ in sequence in the flow direction. In addition, a return line C leads to the storage unit 5′ from a consumer. The storage unit 5′ and thus the cooling circuit, furthermore, are connected by the conduit F to the heating circuit. The illustrated storage unit 5′, like the storage unit 5 of FIG. 4, has a liquid-level float switch 17′ and a safety valve 19′. From the upper area of the storage unit, a conduit leads to the conduit G, from which the conduit O, which represents a connection to the first heating circuit, and a conduit P branch, the branching point being located downstream of a manometer 29, a check valve 25′, a pressure booster 30, and a solenoid-operated valve 18′. From the lower area of the storage unit 5′, a conduit leads by way of a pump unit 20′ to a heater 21′. This has an appropriate temperature sensor 22′ and is designed to heat the medium conveyed to it as desired. From the heater 21′, a conduit leads via a throttle 23′ to a heat exchanger 24′. The conduit is connected downstream of the throttle 23′ via another conduit to a cooling water drain line K, in which a solenoid-operated valve 18′ and a check valve 25′ are installed at intermediate points. The conduit between the throttle 23′ and the heat exchanger 24′, furthermore, is connected by a conduit with a solenoid-operated valve 18′ and a check valve 25′ to the line E, as a result of which a connection is established between the heating circuit and the cooling circuit. The heat exchanger 24′ is also connected to a cooling water inlet J, which has a dirt catcher 28 and two solenoid-operated valves 18′. From the first solenoid-operated valve 18′ downstream of the dirt catcher 28, a conduit branches to the conduit Q. Q leads to the heat exchanger 24 of the heating circuit. The heat exchanger 24 of the heating circuit is also connected via a conduit at R with an intermediate check valve 25′ to the cooling water drain line K. From the heat exchanger 24′ of the cooling circuit, the flowline D leads to the consumer. The flowline D has a feedback connection via a pressure difference transmitter 26′ with a PDS controller to the section of conduit between the pump unit 20′ and the heater 21′. Two temperature sensors 22′, furthermore, detect the temperature of the medium in the flowline D. The detected values are sent via an appropriate connecting line to an SPS 27′, represented by the dash-dot lines. The SPS 27′ processes the detected values and transmits appropriate signals, e.g., actuating signals and the like, to, for example, 18′ or 20′.

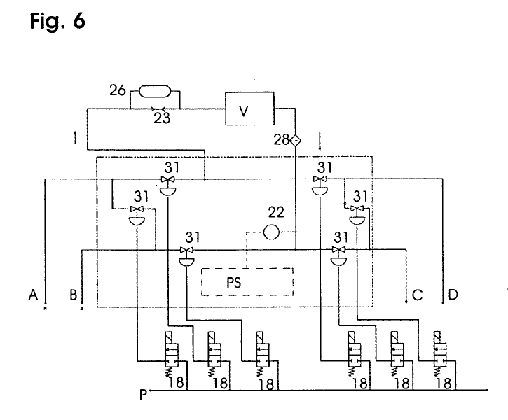

FIG. 6 shows a schematic circuit diagram of a pressure-blanketed tempering system. The core of the connecting means 6 between the two circuits is in the box in dash-dot line. Connected to the core are the two flowlines A, D and the two return lines B, C of the two circuits. The two flowlines A, D can be connected via conduits to pneumatic valves 31. Analogously, the two return lines B, C can be connected via conduits to pneumatic valves 31. The corresponding flowlines and return lines A, D and B, C can be connected upstream of the corresponding pneumatic valves via a conduit, which also has a pneumatic valve 31. Each of these six pneumatic valves 31 can be connected by its own solenoid-operated valve 18 to a compressed air line P. The core of the connection means 6 is formed essentially by the conduits with the six pneumatic valves 31. By means of a controller PS, the corresponding medium can be sent onward to a consumer V, such as a mold. For this purpose, a conduit leads from the conduit between the two pneumatic valves 31 of the two flowlines A, D to the consumer V via a throttle 23, which has an appropriate feedback connection containing a pressure difference transmitter 26 and a PDS controller. Downstream of the consumer V, a conduit leads by way of a dirt catcher 28 to the conduit between the two pneumatic valves 31 of the returns B, C. This conduit to the returns B, C has a temperature sensor 22, which transmits the detected signals to the controller PS.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A tempering system for tempering a connectable piece of equipment, by supplying heat via at least one heating medium, the system comprising:
a first heating medium circuit having a first conduit system through which a heating medium can be transferred at a first temperature and a first unit for tempering the minimum of one heating medium flowing through the first conduit system;
a second heating medium circuit having a second conduit system, through which a heating medium can be transferred at a second temperature and a second unit for tempering the heating medium flowing through the second conduit system; and
connecting means for connecting the first heating medium circuit and the second heating medium circuit to form an integrated unit having an outlet connectable to the connectable piece of equipment, said connecting means selectively allowing the medium of the first temperature or the second temperature to be supplied to the connectable piece of equipment, whereby the medium of the first and second temperatures is available to the connectable piece of equipment in alternation.

2. The tempering system of claim 1, wherein at least one of said first heating medium circuit and said second heating medium circuit includes a storage unit for storing the heating medium.

3. The tempering system of claim 1, wherein said connecting means are arranged and dimensioned so that a supply of the heating medium from one of said first and second heating medium circuits to the outlet is switchable to the other of said first and second heating medium circuits within a time period of ≦10 s.

4. The tempering system of claim 1, wherein each of said first and second conduit systems has at least one inlet and at least one outlet, and wherein said connecting means comprises a switching station having two inlets, said outlets of said first and second conduit systems are respectively connected to said two inlets of said switching station.

5. The tempering system of claim 4, characterized in that said switching station includes at least one outlet which is connectable to the connectable piece of equipment, said switching station comprising a mechanism to selectively connect said outlet of said switching station fluidically to said two inlets.

6. The tempering system of claim 1, wherein said connecting means comprise an equalizing device to equalize a difference with respect to at least one parameter between the heating medium of said first heating medium circuit and the heating medium of said second heating medium circuit.

7. The tempering system of claim 6, wherein said equalizing device comprises a medium return control system configured so that when a supply of heating medium to the outlet is switched from one of the first and second heating medium circuits to the other of the first and second heating medium circuits, the one medium from the one of the first and second heating medium circuits is allowed to flow back, thereby allowing the heating medium from the other of the first and second heating medium circuits to be made available.

8. The tempering system of claim 4, wherein said connecting means comprise an additional conduit system fluidically connecting said first conduit system to said second conduit system of a heating medium circuit upstream of said switching station.

9. The tempering system of claim 8, wherein said connecting means comprise an equalizing device to equalize a difference with respect to at least one parameter between the heating medium of said first heating medium circuit and the heating medium of said second heating medium circuit, said equalizing device being connected to said additional conduit system.

10. The tempering system of claim 1, further comprising at least one controller to control heating by at least one of the first and second units, wherein each of the first and second units comprises a heat exchanger unit.

11. The tempering system of claim 10, wherein said controller controls the heating of both of said first and second units.

12. The tempering system of claim 10, wherein each of said first and second conduit systems has at least one inlet and at least one outlet, said connecting means comprises a switching station having two inlets, and said outlets of said first and second conduit systems are respectively connected to said two inlets of said switching station, said controller being configured to actuate said switching station to realize suitable switchover for ensuring the rapid availability of the first and second temperatures to the connectable piece of equipment.

13. A device for molding workpieces comprising a tempering system and a temperable mold, said tempering system comprising:
a first heating medium circuit having a first conduit system through which a heating medium can be transferred at a first temperature and a first unit for tempering the minimum of one heating medium flowing through the first conduit system;
a second heating medium circuit having a second conduit system, through which a heating medium can be transferred at a second temperature and a second unit for tempering the heating medium flowing through the second conduit system; and
connecting means for connecting the first heating medium circuit and the second heating medium circuit to form an integrated unit having an outlet in working connection with said temperable mold, said connecting means selectively allowing the medium at the first temperature or the second temperature to be supplied to the connectable piece of equipment, whereby the medium at the first and second temperatures is available to the connectable piece of equipment in alternation.

14. The device of claim 13, wherein said mold comprises a channel system arranged for contour-following mold tempering.

15. The device of claim 14, wherein said channel system is fluidically connected the outlet of said connecting means by a channel inlet.

16. The device of claim 14, wherein said channel system comprises a plurality of channels.

17. The device of claim 16, wherein at least one of said channels extends close to a contour surface of said mold, wherein a distance between the contour surface and said at least one of said channels is preferably in a range from ≧0.1 mm to ≦25 mm.

18. The device of claim 16, wherein said at least one of the plurality of channels which extends close to the contour surface is selectively tempered at different temperatures by actuation of said connection means.

19. A process for tempering a device for molding workpieces, the device comprising a tempering system and a temperable mold, said tempering system comprising a first heating medium circuit having a first conduit system through which a heating medium can be transferred at a first temperature and a first unit for tempering the minimum of one heating medium flowing through the first conduit system, a second heating medium circuit having a second conduit system, through which a heating medium can be transferred at a second temperature and a second unit for tempering the heating medium flowing through the second conduit system, and connecting means for connecting the first heating medium circuit and the second heating medium circuit to form an integrated unit having an outlet in working connection with said temperable mold, said connecting means selectively allowing the medium at the first temperature or the second temperature to be supplied to the connectable piece of equipment, whereby the medium at the first and second temperatures is available to the connectable piece of equipment in alternation, said method comprising the steps:
supplying the tempering system with at least one heating medium; and
making available heating medium at first and second temperatures;
connecting the mold to the tempering system; and
tempering the mold by conducting at least one heating medium through the channel system of the mold.

20. The process of claim 19, wherein the connecting step further comprises connecting an inlet of the channel system to an outlet of the connecting means of the tempering system.

21. The process of claim 19, wherein the tempering step further comprises tempering the mold by conducting a heating medium through the mold at the first temperature, switching the means for connecting, and tempering the mold by conducting a heating medium through the mold at the second temperature.

22. A process for producing the device of claim 13, comprising the steps:
producing the tempering system;
producing the mold; and
connecting the tempering system to the mold.

23. The process of claim 22, wherein the production of the mold includes a joining process.
